(19) United States
(12) Patent Application Publication
(10) Pub. No.: US 2012/0199211 A1
(43) Pub. Date: Aug. 9, 2012

(54) AIRFLOW CONTROL SYSTEM

(75) Inventors: Bruce R. Schroder, Agawam, MA (US); Jeffrey Ernst, Wethersfield, CT (US)

(73) Assignee: HAMILTON SUNDSTRAND CORPORATION, Windsor Locks, CT (US)

(21) Appl. No.: 13/022,999

(22) Filed: Feb. 8, 2011

(51) Int. Cl. F15B 5/00

(52) U.S. Cl. 137/14; 137/82

(57) ABSTRACT

An airflow control system for controlling pressure and flow through a flow passage with an upstream portion and a downstream portion includes a valve which can open to different positions for controlling pressure at a downstream portion of the flow passage; a valve actuator which receives electrical signals to control the opening and closing of the valve; and a pneumatic feedback system to stabilize the valve actuator.

### BACKGROUND

The subject matter disclosed herein relates to airflow control and, more particularly, to combined electric and pneumatic valve control.

Bleed systems on aircraft generally involve taking air from the aircraft engine, and regulating it down to a usable temperature and pressure. Pressure is usually regulated through valves, such as butterfly valves being opened certain amounts from zero to ninety degrees, to decrease or increase pressure downstream of the valve. The valves are generally either a proportional valve or an integrating valve, and can be controlled either pneumatically or electronically. Pneumatic control is done through physical components, flow passages, levers, etc. Electronic controls control the valve through electrical signals. Electronic control systems are generally preferred as they allow for more flexibility in control and upgrading or upkeep as compared to pneumatic control systems. This is because upgrading can be done by changing software controlling the valve in electronic systems rather than physically changing components in pneumatic systems. An electronically controlled proportional valve generally is operated by receiving an electrical control signal which corresponds to a valve position. An electronically controlled integrating valve is controlled with an electrical signal that corresponds to a valve velocity, causing the valve to open or close due to the valve travelling at a velocity for a certain amount of time.

It is important to try to maintain stable pressures in the bleed system to improve performance and decrease wear on the system. This includes resisting cycling and input disturbances in the system. Cycling is when pressure values downstream of the valve cycle throughout a range of pressures, to average out to the desired pressure. For example, if the desired pressure is 45 psig, but it is cycling from 40 psig to 50 psig to get an average of 45 psig, that cycling creates a lot of extra wear on system components from the constant fluctuations. The cycling can be due in part to frictional forces that must be overcome to open or close valve. The overcoming of the frictional forces can result in a backlash of force due to the larger amount of force needed to overcome the initial frictional forces to initiate valve movement. Once the initial frictional forces are overcome, the valve can move very rapidly, which can turn into cycling if movement is too rapid and the desired target is overshot. Input disturbances (which can initiate cycling) come from things such as a change in throttle which causes a power change in the engine. Throttling up the engine can cause the pressure to quickly and dramatically change. The bleed system then responds to this rapid change, trying to regulate the pressure to a stable, usable level once again.

### SUMMARY

An airflow control system for controlling pressure and flow through a flow passage with an upstream portion and a downstream portion includes a valve which can open to different positions for controlling pressure at a downstream portion of the flow passage; a valve actuator which receives electrical signals to control the opening and closing of the valve; and a pneumatic feedback system to stabilize the valve actuator.

A method of increasing stability of an electronically controlled valve which regulates pressure at a portion of a flow passage which is downstream of the valve includes controlling valve position through a valve actuator which receives electrical signals; and stabilizing the valve actuator by providing pneumatic feedback to the valve actuator from the portion of the flow passage which is downstream of the valve.

### BRIEF DESCRIPTION OF THE DRAWINGS

FIG. 1 is a block diagram of a valve according to a first embodiment of the current invention.

FIG. 2 is a block diagram of a valve according to a second embodiment of the current invention.

### DETAILED DESCRIPTION

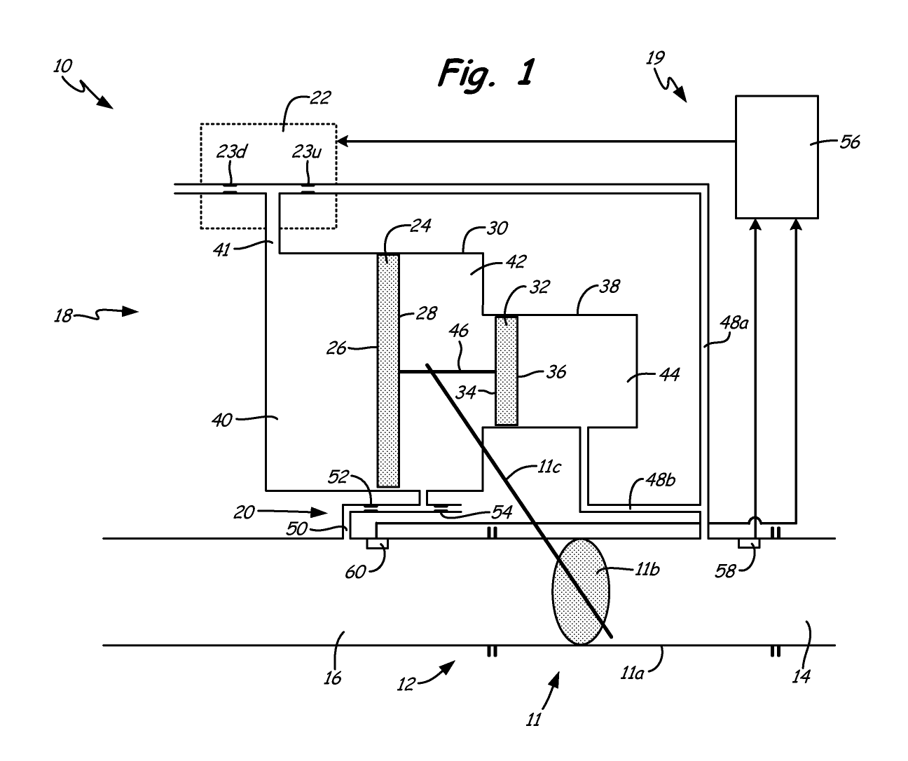

FIG. 1 is a block diagram of a valve according to a first embodiment of the current invention, and includes airflow control system 10 with butterfly valve 11 (with valve housing 11a, disk 11b and shaft 11c), flow passage 12 with upstream portion 14 and downstream portion 16; valve actuator 18, electronic control system 19 and pneumatic feedback system 20. Valve actuator 18 includes torque motor 22 with modulating flow restrictions 23ᵤ and 23_{d}, first piston 24 (with first side 26 and second side 28) in first cylinder 30, second piston 32 (with first side 34 and second side 36) in second cylinder 38, first pressure chamber 40 with flow passage 41, second pressure chamber 42, third pressure chamber 44, connection rod 46, and actuator flow passages 48a, 48b. Pneumatic feedback system 20 includes feedback flow passage 50 with flow restrictions 52 and 54. Electronic control system 19 includes valve controller 56, upstream pressure sensor 58 and downstream pressure sensor 60. While airflow control system 10 uses upstream pressure sensor 58 for electronic control system 19 to anticipate downstream pressure changes, alternative embodiments do not include upstream pressure sensor 58.

Butterfly valve 11 sits in flow passage 12 and disc 11b can rotate between zero and ninety degrees. First piston 24 sits in first cylinder 30. Second piston 32 sits in second cylinder 38. First piston 24 is attached to second piston 32 by connection rod 46. Shaft 11c connects disc 11b to connection rod 46. Flow passage 48a connects upstream portion 14 of flow passage 12 to torque motor 22 and flow passage 48b connects upstream portion 14 of flow passage 12 to third pressure chamber 44. Torque motor 22 connects to first pressure chamber 40 via flow passage 41. Flow passage 50 of pneumatic feedback system 20 connects downstream portion 16 of flow passage 12 to second pressure chamber 42. Controller 56 connects to torque motor 22 and to upstream pressure sensor 58 (when applicable) and downstream pressure sensor 60.

Valve actuator 18 works to rotate valve disk 11b to positions between zero degrees (fully closed) and ninety degrees (fully open) to regulate pressure in the downstream portion 16 of flow passage 12. Rotation is achieved through shaft 11c translating movement of first piston 24 and second piston 32 to rotate valve disk 11b via a lever arm or any other suitable mechanism for translating linear movement into rotation movement known in the art. First piston 24 and second piston 32 move together (due to connection rod 46), with first piston 24 moving through first cylinder 30 and second piston 32 moving through second cylinder 38. First piston 24 and second piston 32 move through cylinders 30, 38 due to respective pressures in first pressure chamber 40, second pressure chamber 42 and third pressure chamber 44. Pressure in first pressure chamber 40 acts on first side 26 of first piston 24. Pressure in first pressure chamber 40 acts an opening force for valve 11. Pressure in second pressure chamber 42 acts on second side 28 of first piston 24 more so than first side 34 of second piston 32 due to the larger surface area of first piston 24. Pressure in second pressure chamber 42 acts as a closing force on valve disk 11b. Pressure in third pressure chamber 44 acts on second side 36 of second piston 32, and acts as a closing force on valve disk 11b. Pressure in third pressure chamber 44 comes from flow passage 48b which feeds pressure from upstream portion 14 of flow passage 12 to third pressure chamber 44.

Pressure in first pressure chamber 40 is regulated by torque motor 22. Torque motor 22 receives pressure from upstream portion of flow passage 12 through flow passage 48a. Torque motor 22 then adjusts the respective sizes of flow restriction 23ᵤ, 23_{d} or both 23ᵤ and 23_{d} in accordance with whether it is trying to close or open valve 11. If torque motor 22 is acting to open valve 11, it will increase pressure in first pressure chamber 40. It will do this by increasing flow area 23ᵤ or decreasing flow area 23_{d} or both by increasing flow area 23ᵤ and decreasing flow area 23_{d}. This will increase pressure in first pressure chamber 40 by forcing pressurized flow from flow passage 48a into first pressure chamber 40 via flow passage 41. This will increase force on first side 26 of first piston 24, causing first piston 24 (and second piston 32) to move. Shaft 11c will translate that movement of pistons 24, 32 into rotation to open valve disk 11b. If torque motor 22 is acting to close valve, it will decrease pressure in first pressure chamber 40 by decreasing flow area 23ᵤ or increasing flow area 23_{d} (which flows to an area of ambient air pressure) or both decreasing flow area 23ᵤ and increasing flow area 23_{d}. This will decrease pressure in first pressure chamber 40, allowing pressure in second pressure chamber 42 and third pressure chamber 44 to act as closing forces, moving first piston 24 and second piston 32, with shaft 11c translating that movement into a closing rotation for valve disk 11b.

Valve actuator 18 is controlled by electronic control system 19. Upstream pressure sensor 58 senses pressure in upstream portion 16 of flow passage 12 and sends a signal indicating the pressure at that point to controller 56. Controller 56 then sends an electrical signal in the form of current to torque motor 22 based on the pressure signal received from upstream pressure sensor 58 and the desired downstream pressure. Current sent to torque motor 22 causes torque motor 22 to modulate flow restrictions 23ᵤ or 23_{d} (or both) to either increase or decrease pressure in first pressure chamber 40 based on whether the upstream pressure indicates that valve 11 should be opened or closed (as described above). Torque motor 22 acts to modulate the applicable flow restrictions 23ᵤ and 23_{d}, which moves pistons 24 and 32, rotating valve disk 11b to either restrict flow or increase flow through flow passage 12. Downstream pressure sensor 60 then senses the pressure in downstream portion 16 of flow passage 12 and sends a signal to controller 56. Controller 56 registers this to determine if control signal sent to torque motor 22 needs to vary to cause valve to open or close to achieve the desired downstream pressure. This electronic control loop is continuous, always trying to achieve a steady, desired pressure value in downstream portion 16 of flow passage 12.

Pneumatic feedback system 20 uses flow passage 50, connected to downstream portion 16 of flow passage 12, to provide pneumatic feedback to valve actuator 18 and to stabilize the position of valve disk 11b. Flow passage 50 feeds the downstream pressure to second pressure chamber 42. Flow passage 50 can be connected to downstream portion 16 of flow passage either within or outside butterfly valve housing 11a. Flow restrictions 52 and 54 are set in flow passage 50 to decrease the pressure into second pressure chamber 42, to ensure that pressure flowing into second pressure chamber 42 is coupled to downstream pressure, but also some amount less than pressure in downstream portion 16. Pressure in second pressure chamber 42 acts as a closing force on valve 11, and must be some amount less than the pressure in downstream portion 16 of flow passage 12 to allow for full opening of valve 11 when desired. Delivering downstream pressure to second pressure chamber 42 helps to slow the movement of first piston 24 and second piston 32, therefore slowing valve disk 11b movement. This slowing of the movement stabilizes valve disk 11b and prevents overshoots which may otherwise lead to cycling. Feeding downstream pressure into second pressure chamber 42 also acts as a pneumatic feedback for valve actuator 18 by coupling downstream pressure to pressure in valve actuator 18. For example, if valve actuator 18 is trying to increase downstream pressure, controller 56 would send a signal to torque motor 22 which modulates applicable flow areas 23ᵤ and 23_{d} to increase pressure in first pressure chamber 40. Increased pressure in first pressure chamber 40 would cause first piston 24 (and second piston 32) to move, and shaft 11c would translate that movement into an opening force for the valve. However, if valve disk 11b opened too much, causing too great of an increase in pressure in downstream portion 16, that pressure (with a slight drop due to restrictions 52 and 54) would be fed back into second pressure chamber 42 and act as a closing force on valve actuator 18.

Actuator 18 with pneumatic feedback system 20 and electronic control system 19 allows for valve 11 to be lightweight, stable, and able to resist input disturbances. This is due to the pneumatic coupling of valve position with pressure in downstream portion 16 of flow passage 12. Past systems simply reacted to pressure in flow passage 12 in trying to regulate pressure in downstream portion 16 to a stable and usable value. The current invention uses both electronic controls (through pressure sensors 58, 60 and controller 56) and pneumatic feedback system 20 to control actuator 18 in regulating downstream pressure resulting in a more stable and accurate system. Pneumatic feedback system 20 works to pneumatically couple downstream pressure to valve disk 11b movement, ensuring airflow control system 10 can more stably and more accurately achieve a desired pressure in downstream portion 16 of flow passage 12. Pneumatic feedback system 20 also works to slow opening and closing movements of valve disk 11b, therefore reducing overshoot which result in cycling due to frictional forces, input disturbances or other stability issues.

Additionally, pneumatic feedback system 20 assists in keeping valve 11 controllable despite valve actuator 18 being small and lightweight. This is due to pneumatic feedback 20 introducing additional force into second pressure chamber 42, to counteract backlash due to frictional forces and other sudden changes which could result in less stable control. In some past systems, valve actuator 18 was made larger to overcome frictional forces and backlash when changing valve position. The current invention overcomes the destabilizing affects of frictional forces by using pneumatic feedback, allowing for economical and flexibility advantages of having a smaller valve actuator 18 while still having the improved controllability of larger valve actuators.

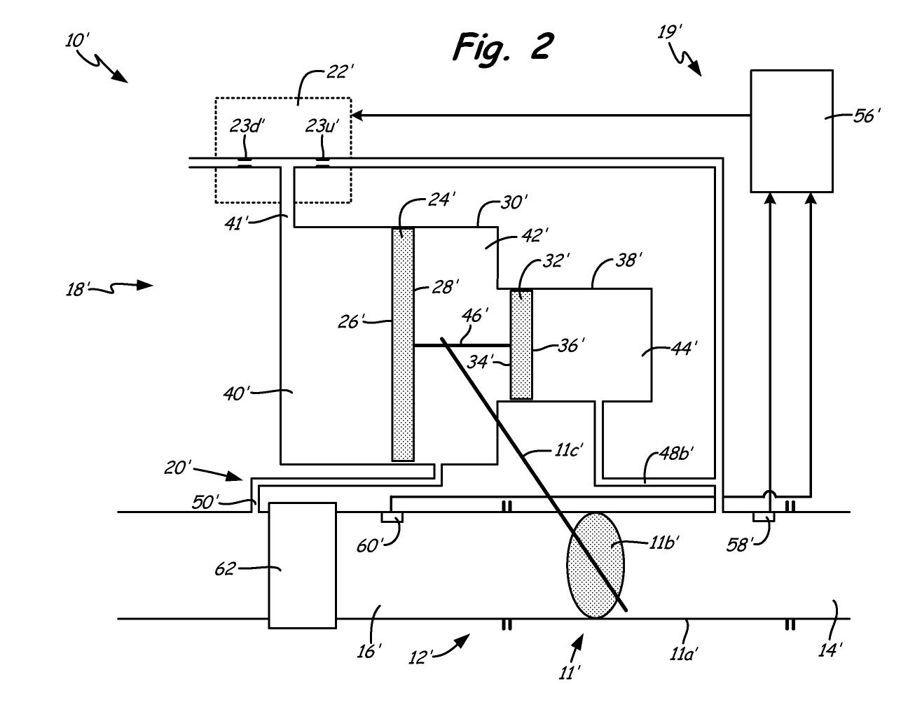

FIG. 2 is a block diagram of a valve according to a second embodiment of the current invention. FIG. 2 works much the same way as FIG. 1 and includes similar components. Components in FIG. 2 are numbered similarly to like components in FIG. 1. FIG. 2 includes airflow control system 10′ with butterfly valve 11′ (with valve housing 11a′, disk 11b′ and shaft 11c′), flow passage 12′ with upstream portion 14′ and downstream portion 16′; valve actuator 18′, control system 19′, pneumatic feedback system 20′ and pre-cooler heat exchanger 62. Valve actuator 18′ includes torque motor 22′ with modulated flow areas 23ᵤ′ and 23_{d}′, first piston 24′ (with first side 26′ and second side 28′) in first cylinder 30′, second piston 32′ (with first side 34′ and second side 36′) in second cylinder 38′, first pressure chamber 40′ with flow passage 41′, second pressure chamber 42′, third pressure chamber 44′, connection shaft 46′ and actuator flow passages 48a′ and 48b′. Control system 19′ includes controller 56′, upstream pressure sensor 58′ and downstream pressure sensor 60′. Pneumatic feedback system 20′ includes feedback flow passage 50′.

Valve actuator 18′ works much like valve actuator 18 in FIG. 1 to open and close valve 11′ to regulate pressure in downstream portion 16′ of flow passage 12′. Valve actuator 18′ opens and closes valve 11′ through moving first piston 24′ and second piston 32′ by torque motor 22′ changing pressure in first pressure chamber 40′ through modulating flow areas 23ᵤ′ and 23_{d}′. Pre-cooler heat exchanger 62 creates a pressure drop in downstream portion 16′ of flow passage 12′. The pressure after this pressure drop is then supplied to second pressure chamber 42′ to give valve actuator 18′ pneumatic feedback, coupling downstream pressure with valve actuator 18′ pressure. This can slow valve disk 11b′ movement by slowing movement of first and second pistons 24′, 32′. While a pre-cooler heat exchanger 62 is shown, any component which results in a downstream pressure drop could be used, including bends, venturis, etc.

As in FIG. 1, valve actuator 18′ with pneumatic feedback system 20′ provides stable control for valve 11′ which resists problems of backlash and cycling of past systems. Pneumatic feedback system 20′ couples pressure in the downstream portion 16′ of flow passage 12′ (the pressure which is being regulated) to the movement of valve disk 11b′. In this second embodiment, the pressure is supplied downstream of a system component which creates a pressure drop. This pressure is supplied into second pressure chamber 42′ to act on first piston 24′ and second piston 32′, coupling pressure in downstream portion 16′ of flow passage 12′ to valve disk 11b′ movement, which is regulating that pressure. This ensures that pressure is regulated more accurately to achieve desired pressure levels downstream and also slows movement of pistons 24′, 32′, thus slowing movement of valve disk 11b′, which reduces cycling. The plumbing pressure downstream from a component which creates a pressure drop ensures the valve 11′ can be fully opened when desired.

In summary, each of airflow control system 10 and 10′ is lightweight and provides stable control of a valve to achieve a desired downstream pressure in a flow passage through the use of an electronically controlled valve actuator with a pneumatic feedback system. The electronically controlled valve actuator allows for the ability to upgrade through software, while the pneumatic feedback system increases stability and control over cycling and provides the ability to couple downstream pressure that is being regulated with the valve that is regulating pressure. This allows for a stable and accurate regulation of downstream pressure through a flow passage. Additionally this allows for a lightweight valve resulting in economic benefits due to weight reduction of the system and less wear due to less cycling without loss of stability or control.

While FIGS. 1-2 show torque motor having two modulating flow areas (23ᵤ, 23_{d}), alternative embodiments could include one flow restriction and one modulating flow area to achieve the same results as using two modulating flow areas. The flow restriction could be located in the flow passage and not in the torque motor 22.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An airflow control system for controlling pressure and flow through a flow passage with an upstream portion and a downstream portion, the system comprising:
a valve which can open to different positions for controlling pressure at a downstream portion of the flow passage;
a valve actuator which receives electrical signals to control the opening and closing of the valve; and
a pneumatic feedback system to stabilize the valve actuator.

2. The system of claim 1, wherein the valve actuator comprises:
a first cylinder;
a first piston with a first side and a second side for moving through the first cylinder;
a second cylinder connected to the first cylinder;
a second piston with a first side and a second side for moving through the second cylinder, and connected to the first piston to move with the first piston;
a first pressure chamber defined by the first cylinder and the first side of first piston;
a second pressure chamber defined by the second side of the first piston and the first side of the second piston;
a third pressure chamber defined by the second cylinder and the second side of the second piston;
a torque motor to control pressure in the first pressure chamber to move the first piston by modulating a restriction to allow pressure from the upstream portion of the flow passage to go into the first pressure chamber or by modulating the restriction to allow pressure to flow out of the first pressure chamber into an area of ambient pressure;
an actuator flow passage connecting the upstream portion of the flow passage to the torque motor and to the third pressure chamber to supply pressure to the torque motor and to the third pressure chamber; and
an actuator shaft connecting the valve to the first piston and the second piston to translate movement of the first piston and the second piston into a change of the valve position.

3. The system of claim 2, wherein the pneumatic feedback system comprises:
a feedback flow passage connecting the downstream portion of the flow passage to the second pressure chamber; and
a pressure drop component so that the feedback flow passage feeds a pressure less than the downstream pressure to the second pressure chamber to couple valve position to the pressure in the downstream portion of the flow passage.

4. The system of claim 3, wherein the pressure drop component comprises:
a first restriction in the feedback flow passage;
a second restriction in the feedback flow passage; and
an opening to an ambient pressure area.

5. The system of claim 3, wherein the pressure drop component comprises a pre-cooler heat-exchanger located in the downstream portion of the flow passage.

6. The system of claim 3, wherein the pressure drop component comprises a bend located in the downstream portion of the flow passage.

7. The system of claim 3, wherein the pressure drop component comprises a venturi located in the downstream portion of the flow passage.

8. The system of claim 2, wherein the torque motor comprises:
a first modulating flow area connected to the actuator flow passage and to the first pressure chamber; and
a second modulating flow area connected to an outlet to an ambient pressure area and to the first pressure chamber, wherein the torque motor modulates the first modulating flow area and the second modulating flow area to increase or decrease pressure in the first pressure chamber.

9. The system of claim 8, wherein the torque motor modulates the first modulating flow area and the second modulating flow area to increase or decrease pressure into the first pressure chamber based on an electric signal which corresponds to a valve position.

10. The system of claim 2, wherein the pressure in the first pressure chamber acts as an opening force on the valve.

11. The system of claim 2, wherein the pressures in the second pressure chamber and the third pressure chamber act as closing forces on the valve.

12. The system of claim 1, wherein the valve is a butterfly valve.

13. A method of increasing stability of an electronically controlled valve which regulates pressure at a portion of a flow passage which is downstream of the valve, the method comprising:
controlling valve position through a valve actuator which receives electrical signals; and
stabilizing the valve actuator by providing pneumatic feedback to the valve actuator from the portion of the flow passage which is downstream of the valve.

14. The method of claim 13, wherein the step of controlling valve position through a valve actuator further comprises:
supplying pressure from a portion of the flow passage upstream of the valve to a torque motor and to a third pressure chamber; and
sending an electrical signal to the torque motor to increase or decrease pressure in a first pressure chamber to provide an opening or a closing force for the valve.

15. The method of claim 14, wherein the step of stabilizing the valve actuator by providing pneumatic feedback to the valve actuator from the portion of the flow passage which is downstream of the valve further comprises:
supplying pressure from a portion of the flow passage which is downstream of the valve;
decreasing the pressure further through the use of a pressure decreasing component; and
introducing the further decreased pressure to a second pressure chamber to act as a stabilizing force on the valve actuator.

16. The method of claim 15, wherein the pressure decreasing component is a plurality of restricted flow areas and an opening to an area of ambient pressure.

17. The method of claim 15, wherein the pressure decreasing component is a component in the downstream portion of the flow passage which creates a pressure drop.

18. The method of claim 17, wherein a feedback flow passage connects the second pressure chamber to the flow passage downstream of the component which creates a pressure drop.

19. The method of claim 17, wherein the component is one of a heat exchanger, a venturi or a bend in the flow passage.

20. A hybrid valve system for controlling pressure in a flow passage at a portion of the flow passage downstream of the valve, the system comprising:
a valve located in the flow passage which can open to different positions;
a valve actuator with a first cylinder with a first piston, the first piston having a first side and a second side; a second cylinder connected to the first cylinder with a second piston, the second piston with a first side and a second side; a first pressure chamber defined by the first cylinder and the first side of first piston; a second pressure chamber defined by the second side of the first piston and the first side of the second piston; a third pressure chamber defined by the second cylinder and the second side of the second piston; a torque motor to control pressure in the first pressure chamber to move the first piston; an actuator flow passage connecting the upstream portion of the flow passage to the torque motor and to the third pressure chamber for the purpose of supplying pressure to the torque motor and to the third pressure chamber; and an actuator shaft connecting the valve to the first piston and the second piston to translate movement of the first piston and the second piston into a change of the valve position; and
a pneumatic feedback system to stabilize the actuator by coupling pressure downstream of the valve to the valve actuator.
